(19) United States
(12) Patent Application Publication
(10) Pub. No.: US 2004/0012978 A1
(43) Pub. Date: Jan. 22, 2004

(54) Direct deposition waveguide mirror

(76) Inventor: Yutaka Doi, Minnetonka, MN (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/198,816

(22) Filed: Jul. 18, 2002

(51) Int. Cl. G02B 6/00

(52) U.S. Cl. 362/551

(57) ABSTRACT

Waveguides formed via direct deposition of reflective material on isolated surfaces of the waveguides rather than on every surface of the waveguides are described. It is contemplated that direct deposition facilitates deposition on isolated surfaces. Deposition only on isolated surfaces reduces costs and risks. Cost is reduced by reducing the amount of reflective material required. Risk of metal particles plugging the waveguide reduced both by the decrease in amount of reflective material used, and in the method of depositing it.

### FIELD OF THE INVENTION

The field of the invention is optical board waveguides.

### BACKGROUND OF THE INVENTION

An optical board, as the term is used herein, is a board (possibly a printed wiring board) or other support structure that comprises one or more optical waveguides. An optical waveguide is a structure that “guides” a light wave by constraining it to travel along a certain desired path. A waveguide traps light by surrounding a guiding region, called the core, with a material called the cladding, where the core is made from a transparent or translucent material with higher index of refraction than the cladding.

In some instances, the optical waveguides of an optical board will include one or more surface traces, such traces frequently comprising an optical resin deposited on a substrate to form a ridge waveguide. In some instances an optical board may comprise a plurality of parallel traces.

### SUMMARY OF THE INVENTION

The present invention is directed to waveguides formed via direct deposition of reflective material on isolated surfaces of the waveguides rather than on every surface of the waveguides. It is contemplated that direct deposition facilitates deposition on isolated surfaces. Deposition only on isolated surfaces reduces costs and risks. Cost is reduced by reducing the amount of reflective material required. Risk of metal particles plugging the waveguide reduced both by the decrease in amount of reflective material used, and in the method of depositing it.

In preferred embodiments, elongated waveguides having a rectangular cross section are terminated at one or both ends by surfaces angled at forty-five degrees relative to the central axis of the waveguide, with the angled surfaces being the only portions of the wave guide coated with a reflective material. For a majority of the waveguide, the “cladding” is simply the surface which surrounds the “core” and the core is not coated with a reflective coating.

Various objects, features, aspects and advantages of the present invention will become more apparent from the following detailed description of preferred embodiments of the invention, along with the accompanying drawings in which like numerals represent like components.

### BRIEF DESCRIPTIONS OF THE DRAWINGS

FIG. 1 is a front view of an optical board embodying the invention.

FIG. 2 is a cutaway top view of the optical board of FIG. 1.

FIG. 3 is a side view of the optical board of FIG. 1.

### DETAILED DESCRIPTION

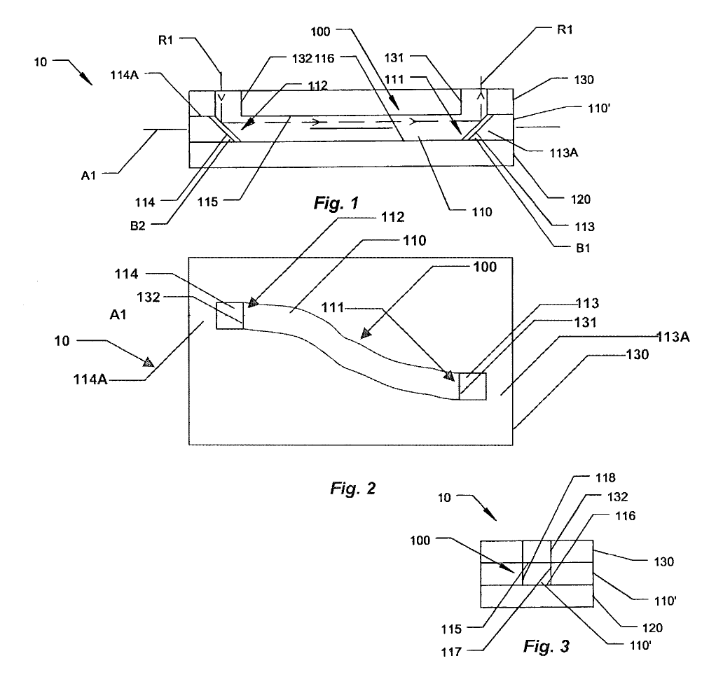

Referring first to FIGS. 1-3, optical board 10 comprises a non-polymeric waveguide 100 as part of waveguide layer 110′, a substrate 120, and an encapsulating layer 130. Non-polymeric waveguide preferably is made of glass. Waveguide 100 comprises an elongated segment 110 whose cross section is symmetrical around a central axis A1 passing through the length of the segment 110. Ends 111 and 112 of segment 110 each comprise an angled surface 113 or 114 that is neither perpendicular to, nor parallel with, the central axis A1 of the segment 110, but instead forms an angle B1 or B2 with axis A1. Angled surfaces 113 and 114 are mirrored. Top wall 115 and bottom wall 116 are not mirrored, nor are side walls 117 and 118. As can be seen, surfaces 113 and 114 are tilted at a forty-five degree angle relative to axis A1. Waveguide 100 has a rectangular cross section formed by walls 115-118. Optical vias 131 and 132 permit light to pass into and/or out of waveguide 100 through covering/encapsulating layer 130. As an example, light ray R1 is provided to illustrate a possible path for light to follow while entering, passing through, and exiting waveguide 100. As viewed from the top, the “core” 110 is generally curved and light ray is guided through the core by means of the total reflection at the walls around the core.

Elongated segment 110 preferably comprises a transparent or translucent material such as tantalum oxide. A translucent material may be used as segment 110 so long as the index of refraction of segment 110 is greater than that of substrate 120 and any other substance surrounding segment 110 such as layer 130 and the remainder of layer 110′. Segment 110 may comprise any cross-sectional shape although preferred embodiments will be symmetrical around central axis A1. As such, circular, square, and rectangular shapes are all preferred shapes with rectangular being the most preferred.

In preferred embodiments, surfaces 113 and 114 will comprise a metal layer supported by a substrate. In the figures, surfaces 113 and 114 are supported by members 113A and 114A. It is preferred that the metal layer be formed on the substrate by way of direct deposition, possibly using the apparatus described in any one of U.S. Pat. Nos. 6,391,251, 6,268,584, and 6,251,488, each of which is herein incorporated by reference in its entirety. As such, a method of forming waveguide 100 comprises directly depositing a metal layer on top of one or two angled surfaces positioned at ends of the waveguide, and preferably preventing metal from being deposited on any wall or other portion of the waveguide. In some instances, support members 113A and 114A may also be formed by direct deposition. Direct deposition of a 45 degree mirror at both ends of a rectangular channel makes it a simple, efficient planar optical waveguide by coupling the light beam between optical devices and the waveguide without mirror coating over the rest of the optical layer.

It is contemplated that waveguides as disclosed herein may advantageously be used in numerous applications, but are particularly suited for use in optical back planes and optical printed circuit/wiring boards.

Thus, specific embodiments and applications of optical waveguides have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A non-polymeric waveguide comprising one or more elongated segments, each segment being symmetrical around a central axis passing through the length of the segment, each elongated segment having at least one end comprising an angled surface that is neither perpendicular to, nor parallel with, the central axis of the segment, wherein the angled surface is mirrored, and at least portions of the walls of the waveguide are not mirrored.

2. The waveguide of claim 1 wherein the angled surfaces of each segment are the only mirrored portions of the segment.

3. The waveguide of claim 2 wherein both ends of at least one segment comprise angled surfaces, where the angled surfaces are not parallel to each other.

4. The waveguide of claim 3 having a square or a rectangular cross section.

5. The waveguide of claim 4 wherein each segment of the waveguide comprises a planar wall in addition to an angled surface, and the angled surface lies in a plane tilted 45 degrees relative to the planar wall.

5. The waveguide of claim 1 wherein the angled surfaces of each segment comprise a metal layer coating a supporting layer.

6. The waveguide of claim 1 wherein the angled surface is formed by direct deposition.

7. A method of forming a non-polymeric waveguide comprising directly depositing a metal layer on top of an angled surface positioned at an end of the waveguide.

8. The method of claim 7 comprising preventing metal from being deposited on any wall or other portion of the waveguide other than the angled surface.

9. The method of claim 8 wherein the waveguide comprises a planar wall in addition to the angled surface, and the angled surface lies in a plane tilted 45 degrees relative to the planar wall.
